(19) United States
(12) Patent Application Publication
(10) Pub. No.: US 2026/0163446 A1
(43) Pub. Date: Jun. 11, 2026

(54) FLYWHEEL-BASED ENERGY SUPPLY AND STORAGE SYSTEM

(71) Applicant: FENG-TIEN CHEN, TAICHUNG CITY (TW)

(72) Inventor: FENG-TIEN CHEN, TAICHUNG CITY (TW)

(21) Appl. No.: 19/178,959

(22) Filed: Apr. 15, 2025

Related U.S. Application Data
(63) Continuation-in-part of application No. 18/640,312, filed on Apr. 19, 2024.
(63) Continuation-in-part of application No. 18/640,192, filed on Apr. 19, 2024, now Pat. No. 12,456,902.

(51) Int. Cl. H02K 7/02; F03G 3/08

(52) U.S. Cl. CPC H02K 7/025; F03G 3/08

(57) ABSTRACT

A flywheel-based energy supply and storage system comprises a flywheel device. The flywheel device comprises a mounting base, a screw member, a pair of masses, and a spring member. The screw member includes a screw shaft and a pair of nuts. The screw shaft is radially pivoted within the mounting base and has a left section with forward threads, and a right section with reverse threads. One of the two nuts is engaged with the left section of the screw shaft and coupled to one of the masses, the other nut is engaged with the right section of the screw shaft and coupled to the other mass. The spring member is disposed within the mounting base in a manner that allows the masses to move toward or away from each other in a stable manner.

This application is a continuation-in-part of copending U.S. patent application Ser. No. 18/640,312, filed on Apr. 19, 2024, and copending U.S. patent application Ser. No. 18/640,192, filed on Apr. 19, 2024, all of which are hereby incorporated by reference.

### BACKGROUND OF THE INVENTION

### 1. Field of the Invention

The invention relates to the technical field of power generation and storage System, and in particular to a flywheel-based Energy Supply and Storage System.

### 2. Description of the Related Art

Flywheel energy conversion technology has played an increasingly important role in recent years due to its advantages, such as fast start-up capacity, low maintenance costs, long lifespan, environmental friendliness, efficient energy storage, quick charging, and unlimited charge/discharge cycles. The flywheels currently used in energy conversion equipment typically have a fixed moment of inertia, as disclosed in U.S. Pat. Nos. 4,612,494 and 10,122,240. Unfortunately, these flywheels not only require substantial energy input to overcome frictional and aerodynamic losses during start-up but also fail to provide an adequate solution to the problem of decreasing rotational speed when converting kinetic energy into electrical energy.

While U.S. Pat. No. 7,044,022 introduced an improved flywheel with a variable moment of inertia, its design still suffers from instability issues and fails to sufficiently mitigate the energy losses associated with inertia adjustment. Furthermore, adjusting the moment of inertia can introduce dynamic balance issues, leading to increased vibration and reducing overall system efficiency.

### SUMMARY OF THE INVENTION

The inventor has recognized that by ensuring the moment of inertia of a flywheel can vary stably with its rotation speed, the aforementioned drawbacks of the prior art flywheel can be effectively addressed.

Thus, in one aspect of the present invention, a flywheel-based energy supply and storage system is disclosed. The flywheel-based energy supply and storage system comprises a flywheel device. The flywheel device comprises a mounting base, a screw member, and a pair of masses. The screw member includes a screw shaft and a pair of nuts. The screw shaft is radially pivoted within the mounting base and has a middle section, a left section with forward threads, and a right section with reverse threads. One of the two nuts is engaged with the left section of the screw shaft, and the other nut is engaged with the right section of the screw shaft, allowing each nut to move back and forth between a starting position and an ending position. One of the masses is coupled to the nut engaged with the left section of the screw shaft, and the other mass is coupled to the nut engaged with the right section of the screw shaft. This allows the masses to approach or move away from the middle section synchronously, altering the moment of inertia of the flywheel device. Consequently, the rotating speed of the flywheel device can be detected by observing the change in moment of inertia, which helps determine the mode in which the rotating electrical machine should operate. It is further noted that, in some embodiments of the present invention, a high-performance linear screw member is utilized. The screw shaft may, for instance, be selected from a ball screw or a roller screw, and the corresponding nut may be a ball nut or a roller nut, thereby achieving a balance between positioning accuracy and load capacity.

In another aspect of the present invention, the flywheel device further comprises a spring member disposed within the mounting base in a manner that allows the masses to move toward or away from each other in a stable manner.

In another aspect of the present invention, the flywheel-based energy supply and storage system further comprises a rotating electrical machine. The rotating electrical machine comprises a frame, a rotor with a centrally fixed shaft, a first stator and a second stator. The rotor, first stator, and second stator are accommodated inside the frame, where the rotor is configured to rotate through electromagnetic interaction with the first and/or second stator, and the shaft rotates together with the rotor. Thus, when coupled with the flywheel device, the rotating electrical machine can operate in both energy storage and supply modes.

### BRIEF DESCRIPTION OF THE DRAWINGS

Other features and advantages of the disclosure will become readily apparent to those skilled in the art from the following detailed description of the embodiments in the light of the accompanying drawings, in which:

FIG. 1 is a perspective view of a first embodiment of the invention;

FIG. 2 is a cross-sectional view taken along the direction 2-2 of FIG. 1;

FIG. 3 is a partially exploded perspective view of the flywheel device of the first embodiment of the invention shown in FIG. 1;

FIG. 4 is a top view of some parts assembled of the flywheel device shown in FIG. 3;

FIG. 5 is a top view of some parts assembled of the flywheel device shown in FIG. 3, when the two masses thereof approach to each other;

FIG. 6 is a top view of some parts assembled of the flywheel device shown in FIG. 3, when the two masses thereof move away from each other;

FIG. 7 is an exploded view of a rotating electrical machine of the first embodiment of the invention shown in FIG. 1;

FIG. 8 is a schematic diagram of the electrical connection between the first embodiment of the invention shown in FIG. 1 and an external power supply during operation.

FIG. 9 is a partially exploded perspective view of the flywheel device of a second embodiment of the invention;

FIG. 10 is a top view of some parts assembled of the flywheel device shown in FIG. 10;

FIG. 11 is a top view of some parts assembled of the flywheel shown in FIG. 10, when the two masses thereof approach to each other;

FIG. 12 is a partially exploded perspective view of the flywheel device of a third embodiment of the invention;

FIG. 13 is a top view of some parts assembled of the flywheel device shown in FIG. 12;

FIG. 14 is a cross-sectional view taken along the direction 14-14 of FIG. 13, when the two masses thereof approach to each other;

FIG. 15 is a cross-sectional view taken along the direction 14-14 of FIG. 13, when the two masses thereof move away from each other;

FIG. 16 is a partially exploded perspective view of the flywheel device of a fourth embodiment of the invention;

FIG. 17 is a cross-sectional view of the flywheel device of the embodiment shown in FIG. 16; and

FIG. 18 is a cross-sectional view of the flywheel device of a fifth embodiment of the invention.

### DETAILED DESCRIPTION OF THE INVENTION

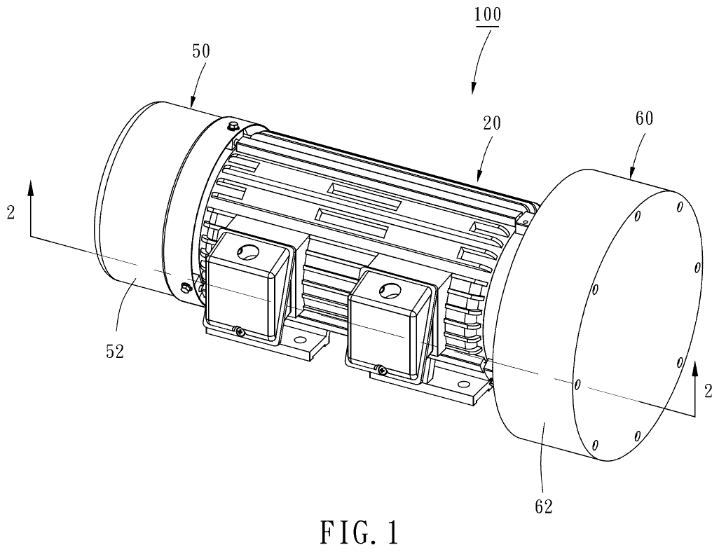

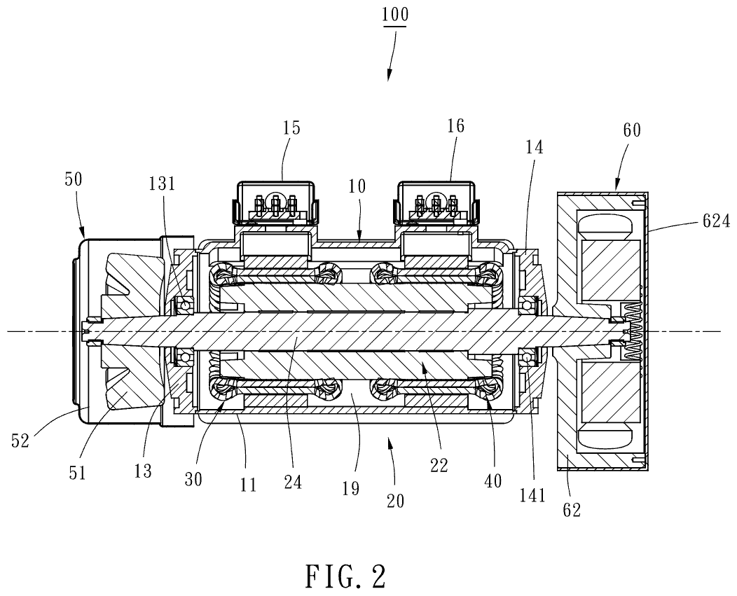

Referring firstly to FIG. 1 to FIG. 2, a flywheel-based energy supply and storage system embodied according to the invention is shown at 100. The system 100 comprises a rotating electrical machine 20, a cooling device 50 and a flywheel device 60.

Next, referring to FIGS. 2 to 6, the flywheel device 60 comprises a mounting base 62, which is fixed to a shaft 24 of a rotor 22 of the rotating electrical machine 20. The device 60 further includes a pair of masses 63 and a pair of ball screw members 64.

The base 62 includes a base plate 620, an annular wall 622 extending upward from the periphery of the base plate 620, a receiving space 623 defined by the base plate 620 and the annular wall 622, and an outer cover 624 fixed to the upper end of the annular wall 622. The base plate 620 has a convex ring 625 extending inward along its axis and an axis hole 626. When assembled, the first end of the shaft 24 penetrates the convex ring 625 through the axis hole 626 and is then secured with a nut 627.

Each of the ball screw members 64 has a ball screw shaft 640 and a pair of ball nuts 642. The ball screw shafts 640 are received in the receiving space 623 at intervals and radially fixed on the annular wall 622 by first bearings 641 and second bearings 643.

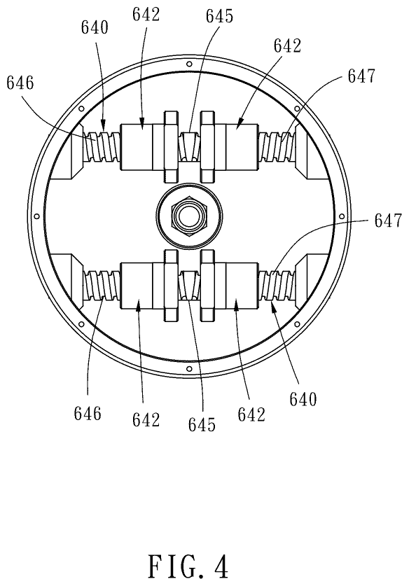

As shown in FIG. 4, each ball screw shaft 640 includes a middle section 645, a left section 646 with forward threads, and a right section 647 with reverse threads. The right section 647 is equal in length to the left section 646. One of the two ball nuts 642 is mounted on the left section 646, while the other is mounted on the right section 647, allowing each ball nut 642 to move back and forth between its starting and ending positions.

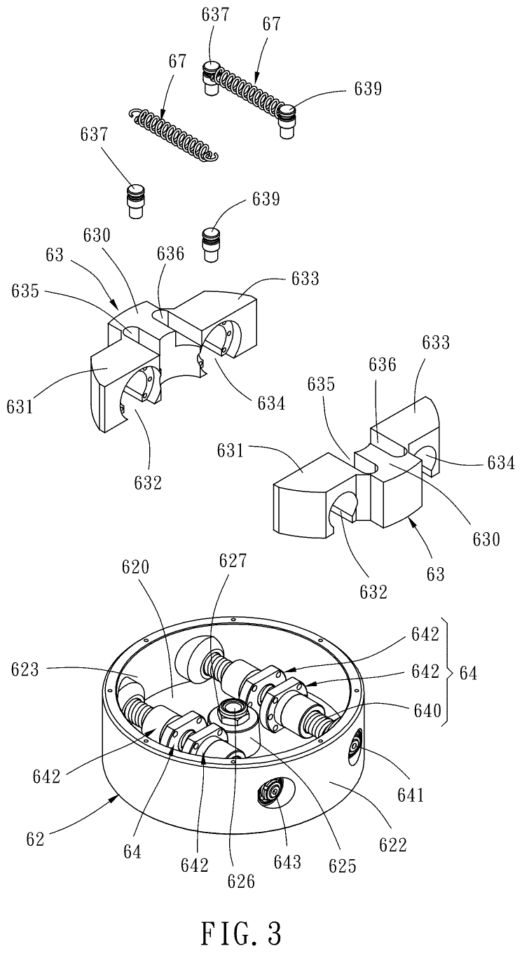

As shown in FIG. 3, each of the masses 63 has a central portion 630, a left wing portion 631 with a left recess 632, and a right wing portion 633 with a right recess 634. When assembled, the ball nuts 642 screwed to the left sections 646 of the screw shafts 640 are received in the left recess 632 and the right recess 634 of one of the masses 63, while the ball nuts 642 screwed to the right sections 647 of the screw shafts 640 are received in the left recess 632 and the right recess 634 of the other mass 63. This arrangement allows the masses 63 to move synchronously with the ball nuts 642

In this embodiment, the flywheel device 60 further comprises a pair of spring elements 67. The central portion 630 of each mass 63 is provided with a left groove 635 and a right groove 636. One end of each spring element 67 is fixed in the left groove 635 of one mass 63 by a first pin 637, while the other end is fixed in the left groove 636 of the other mass 63 by a second pin 639. Thereby, the spring elements 67 ensure the masses 63 move toward each other when the flywheel device's rotational speed decreases.

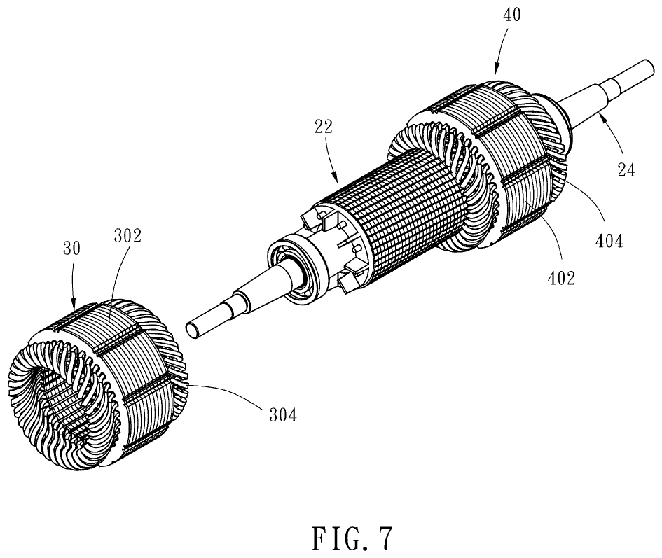

Now, referring to FIG. 2 and FIG. 7, the rotating electrical machine 20 comprises a frame 10, a rotor 22 with a centrally fixed shaft 24, a first stator 30, and a second stator 40.

The frame 10 includes a casing 11, a first bearing seat 13, a second bearing seat 14, a first connection box 15, and a second connection box 16. The first bearing seat 13, which holds a first bearing 131, and the second bearing seat 14, which holds a second bearing 141, are respectively mounted on both ends of the casing 11 to define a receiving space 19. The first connection box 15 and the second connection box 16 are fixed on the surface of the casing 11.

The rotor 22 has a core portion stacked with multiple silicon-steel sheets to serve as a magnetic flux path, and it is disposed in the receiving space 19. The shaft 24 is fixed to the center of the rotor 22. The first end of the shaft 24 is pivotally connected to the first bearing 131 and extends outside of the casing 11, while the second end of the shaft 24 is pivotally connected to the second bearing 141 and also extends outside of the casing 11.

The first and second stators 30, 40 each include a respective stator body 302, 402 composed of a plurality of annular silicon-steel sheets, and a first and second stator winding unit 304, 404 installed within the first and second stator bodies 302, 402. In this embodiment, the first and second stators 30, 40 are respectively fixed in the casing 11 and positioned in the receiving space 19 such that they are spaced apart from each other by a predetermined distance and form an air gap with the rotor 22. The cooling fan 50 is coupled to the first end of the shaft 24 and driven by it. In another embodiment, the cooling device 50 may also be another flywheel with the same structure as the flywheel 60. In this embodiment, the cooling device 50 comprises a cooling fan 51 enclosed by an end cover 52.

The following is a detailed description of the operation of the rotating electrical machine 10.

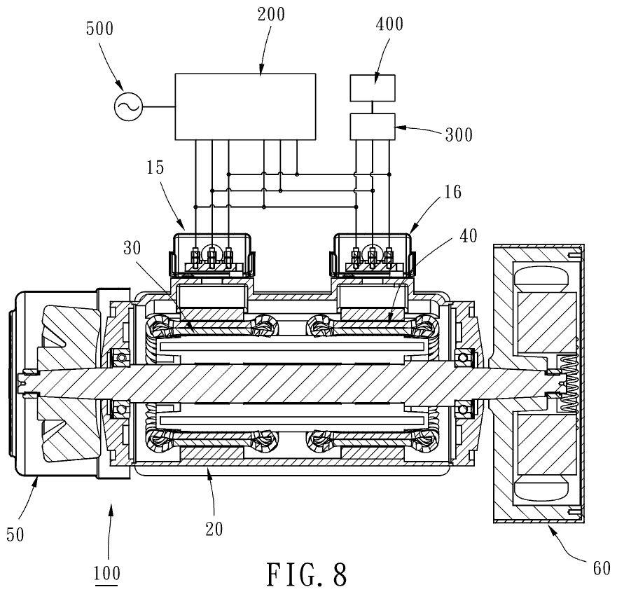

Please referring to FIG. 8, the flywheel-based energy supply and storage system 100 can be operated with a control device 200, a voltage stabilizer 300 and an external load 400.

The first input end of the first stator 30 is located in the first connection box 15. The second input end and the output end of the second stator 40 are located in the second connection box 16. The control device 200 includes an input end connected to an external power supply 500 and an output end connected respectively to the input end of the first stator 30 and the input end of the second stator 40. The voltage stabilizer 300 has an input end connected to the output end of the second stator 40 and an output end connected to the input end of the external load 400. When the control device 200 connects both the first stator 30 and the second stator 40 to the external power supply 500, the rotating electrical machine 20 operates in motor mode, also known as energy storage mode, to drive the flywheel device 60. Once the flywheel device 60 reaches a certain speed, the second stator 40 is disconnected from the external power supply 500, switching the rotating electrical machine 20 to energy supply mode. In this state, the second stator 40 works together with the rotor 22 to function in generator mode.

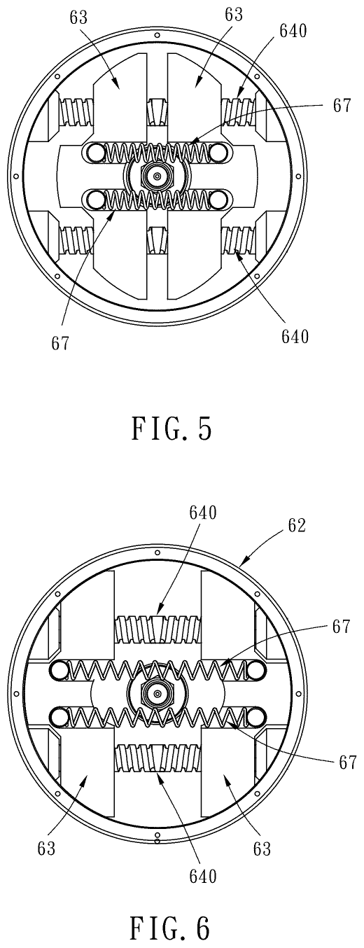

In more detail, before the flywheel device 60 is activated, the masses 63 are positioned at the middle sections 645 of the screw shafts 640, which serve as the starting points, as shown in FIG. 5. As the rotational speed of the flywheel device 60 gradually increases, the masses 63 are affected by centrifugal force and move synchronously from the starting points to the end points along the screw shafts 640. When the flywheel device 60 reaches a certain speed, the masses 63 arrive at the end points, as shown in FIG. 6. At this stage, the control device 200 switches the system from energy storage mode to power supply mode, allowing the external power supply 500 to deliver power to the first stator 30 while disconnecting from the second stator 40. Consequently, the second stator 40 operates in conjunction with the rotor 22 in generator mode. The electrical energy generated by the flywheel-based energy supply and storage system 100 is then supplied to the external load 400, such as batteries or capacitors, via the voltage stabilizer 300.

It must be mentioned here that since the moment of inertia of the flywheel device 60 is variable, when the moment of inertia reduces to a predetermined value during the energy release process, the control device 200 will detect this value and reconnect the second stator 40 to the external power supply 500. This allows the rotating electrical machine 100 to operate in energy storage mode, thereby maintaining stability in the output electrical energy.

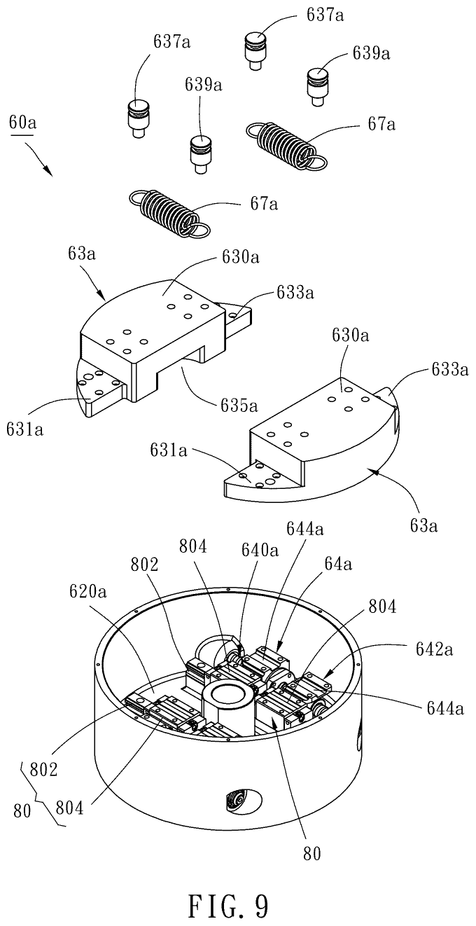

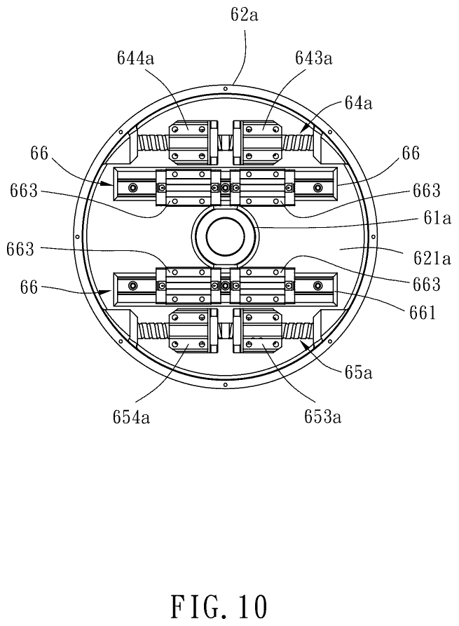

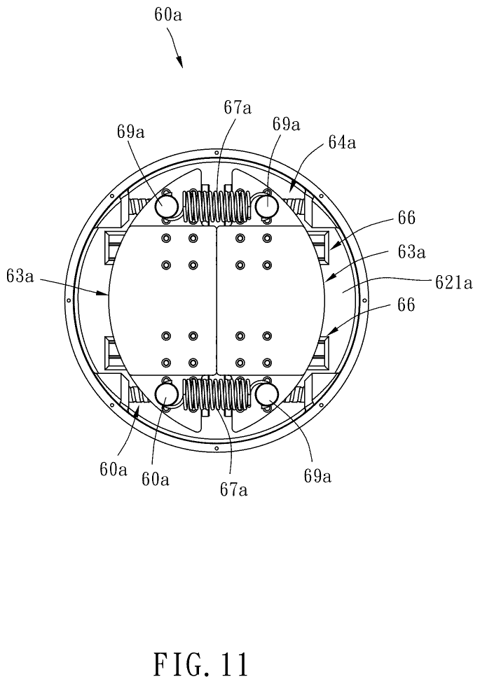

Referring to FIGS. 9 to 11, a flywheel device according to another embodiment of the invention is shown as 60a. The difference between the flywheel device 60a and the flywheel device 60 is the inclusion of a pair of linear guide devices 80. Each linear guide device 80 comprises a track member 802 with a fist section 806 and a second section 808, and a pair of moving member 804 respectively coupled to the first section 806 and the second section 808. The track member 802 is fixed on the base plate 620a parallel to and adjacent to the screw shaft 640a of the ball screw device 64a. The moving member 804 is assembled to the track member 802 with a plurality of balls serving as rolling elements (not shown in the FIGS.).

Each mass 63a has a central portion 630a with an opening recess 635a, a left wing portion 631a, and a right wing portion 633a. The moving members 804 on one side of the track members 802 are received and fixed in the opening recess 635a of one mass 63a. The moving members 804 on the other side of the track members 802 are received and fixed in the opening recess 635a of the other mass 63a.

In this embodiment, each ball nut 642a has an upper portion 644a. When assembled, the ball nuts 642a screwed to the left sections 646a of the ball screw shafts 640a are fixed on the left wing portion 631a and the right wing portion 633a of one mass 63a by the upper portion 644a. The ball nuts 642a screwed to the right sections 647 of the ball screw shafts 640a are fixed on the left wing portion 631a and the right wing portion 633a of the other mass 63a by the upper portion 644a.

Additionally, the flywheel device 60a includes a pair of spring elements 67a. One end of one of the spring elements 67a is fixed to the left wing portion 631a of one mass 63a with a first pin 637a, while the other end thereof is fixed to the left wing portion 631a of the other mass 63a with a second pin 639a. One end of the other spring element 67a is fixed to the right wing portion 633a of one mass 63a with another pin 637a, while the other end thereof is fixed to the right wing portion 633a of the other mass 63a with another second pin 639a. Therefore, even when the weight of the mass 63a is greater than that of the mass 63, the mass 63a can move smoothly back and forth between the starting point and the end point with the assistance of the spring elements 67a.

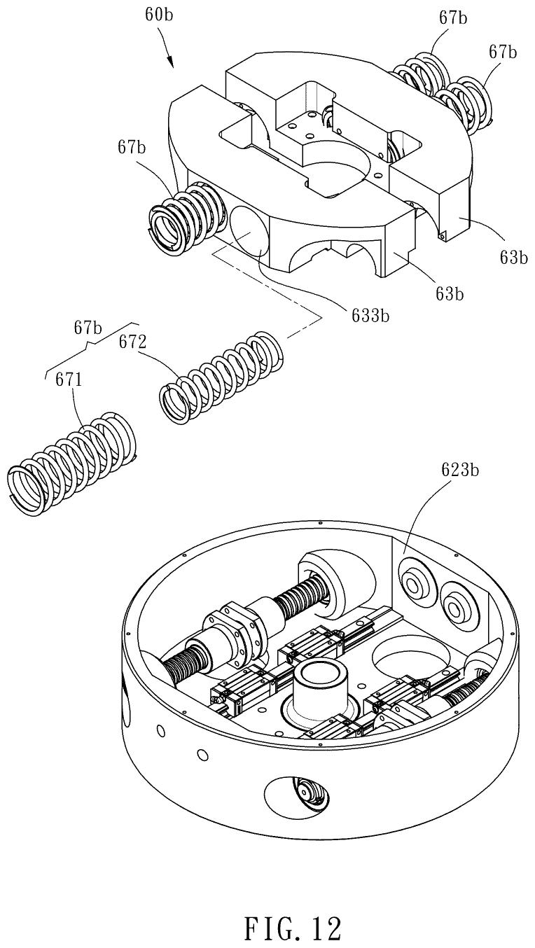

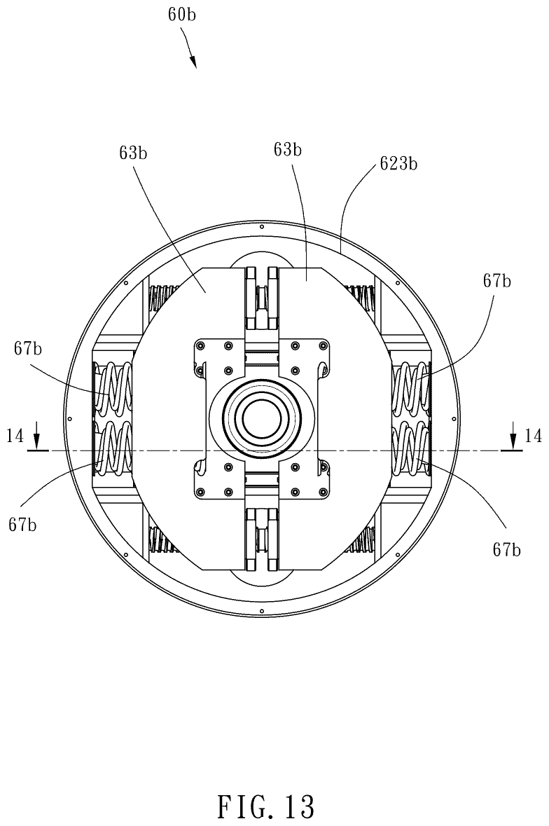

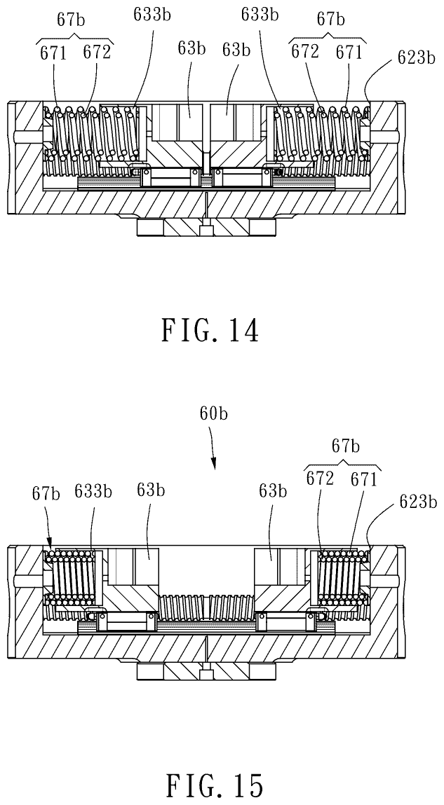

Referring to FIGS. 12 to 15, a flywheel device according to a third embodiment of the invention is designated as 60b. The primary difference between flywheel device 60b and the flywheel device 60 is that flywheel device 60b includes four spring elements 67b, each comprising a first spring 671 and a second spring 672. The second spring 672 is nested within the first spring 671 to enhance the elastic support force of the spring element 67b. One end of each spring element 67b abuts against the mass 63b, while the other end rests against the annular wall 623b. This configuration positions each spring element 67b between the mass 63b and the annular wall 623b. In this embodiment, the openings of the grooves 633b in the masses 63b face the annular wall 623b, with one end of each spring element 67b housed within the corresponding groove 633b. When the masses 63b move outward due to centrifugal force, the spring elements 67b are compressed. As the rotational speed of the flywheel device 60b decreases and centrifugal force weakens, the stored energy in the compressed spring elements 67b is released, synchronously driving the masses 63b inward toward the middle section.

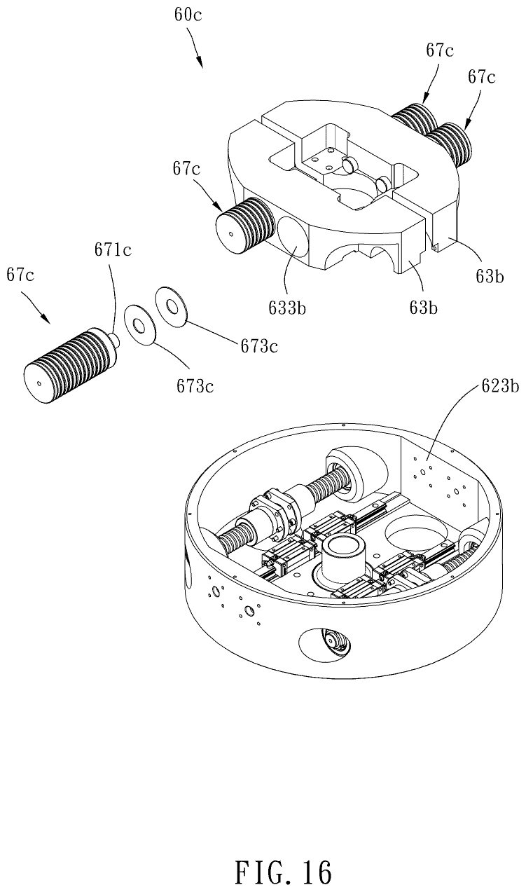

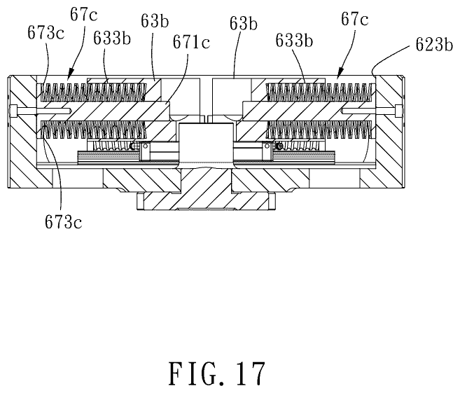

Referring to FIG. 16 and FIG. 17, a flywheel device according to a fourth embodiment of the invention is designated as 60c. The primary difference between flywheel device 60c and the flywheel device 60b is that the flywheel device 60c includes four sets of disc spring elements 67c, each comprising a support post 671c and multiple disc spring plates 673c fitted onto the spring post 671c, forming a layered elastic cushioning structure. One end of the spring post 671c is fixed to the annular wall 623b, while the other end is positioned within the positioning groove 633b of the mass 63b. When the masses 63b are subjected to centrifugal force, the disc spring plates 673c are compressed and deformed due to the axial thrust, storing energy. As the centrifugal force decreases, the disc spring plates 673c release the stored energy, driving the masses 63b back toward the middle section.

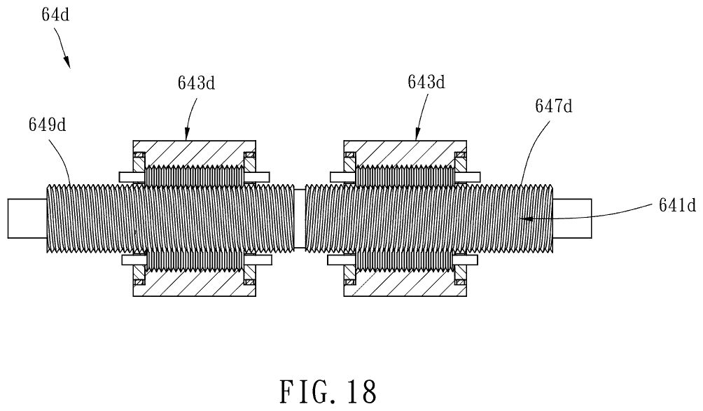

Referring to FIG. 18, a screw member of a flywheel device according to a fifth embodiment of the invention is designated as 64d. The screw member 64d includes a roller screw shaft 641d and a pair of roller nuts 643d. The two roller nuts 643d are respectively disposed on the right-hand threaded section 647d and the left-hand threaded section 649d of the roller screw shaft 641d, and are each connected to a respective mass.

What is claimed is:

1. A flywheel-based energy supply and storage system, comprising:
a flywheel device comprising:
a mounting base;
a screw member including:
a screw shaft radially pivoted within the mounting base and having a middle section, a left section with forward threads, and a right section with reverse threads;
a pair of nuts, one of the two nuts being engaged with the left section of the screw shaft, and the other nut being engaged with the right section of the screw to allow each nut to move back and forth between a starting position and an ending position;
a pair of masses, one of the masses being coupled to the nut engaged with the left section of the screw shaft, and the other mass being coupled to the nut engaged with the right section of the screw shaft to allow the masses to approach or move away from the middle section synchronously, thereby enabling the moment of inertia of the flywheel to be variable; and
a spring member disposed within the mounting base in a manner that allows the masses to move toward or away from each other in a stable manner.

2. The flywheel-based energy supply and storage system of claim 1, wherein the screw member includes a ball screw and a pair of ball nuts, or a roller screw and a pair of roller nuts.

3. The flywheel-based energy supply and storage system of claim 1, further comprising a rotating electrical machine comprising:
a frame,
a rotating device including a rotor and a shaft fixed to the center of the rotor,
a first stator and a second stator being respectively accommodated inside the frame in a way that the rotor is configured to rotate by electromagnetically interacting with the first stator or/and the second stator, and the shaft rotates together with the rotor; and being respectively are accommodated inside the frame in a way that the rotor is configured to rotate by electromagnetically interacting with the first stator or/and the second stator, and the shaft rotates together with the rotor.

4. The flywheel-based energy supply and storage system of claim 3, wherein the first stator includes a first input and/or output end, and the second stator includes a second input and/or output end, thereby when both the first stator and the second stator are connected to an external power supply through their respective input ends, the rotating electrical machine operates in the energy storage mode, conversely, when only the first input end of the first stator is connected to the external power supply, the rotating electrical machine can output electrical energy through the second output end of the second stator.

5. A flywheel-based energy supply and storage system, comprising:
a flywheel device comprising:
a mounting base;
a pair of screw members;
a pair of masses;
each of the screw members including a screw shaft and a pair of nuts;
the screw shaft radially pivoted within the mounting base and having a middle section, a left section having forward threads, and a right section having reverse threads, one of the nuts screwed to the left section and the other nut screwed to the right section to allow each of the nuts moving back and forth between a starting position and an ending position;
one of the masses being coupled to the nuts screwed to the left sections of the screw shafts and the other mass being coupled to the nuts screwed to the right sections of the screw shafts to allow the masses approaching or moving away from the middle section synchronously, thereby enabling the moment of inertia of the flywheel to be variable; and
a spring member disposed within the mounting base in a manner that allows the masses to move toward or away from each other in a stable manner.

6. The flywheel-based energy supply and storage system of claim 5, wherein the screw member includes a ball screw and a pair of ball nuts, or a roller screw and a pair of roller nuts.

7. The flywheel-based energy supply and storage system of claim 5, wherein the mounting base includes a base plate, an annular wall extending upward from the periphery of the base plate, a receiving space defined by the base plate and the annular wall.

8. The flywheel-based energy supply and storage system of claim 7, wherein each of the masses has a left wing portion with a left recess, and a right wing portion with a right recess, the nuts screwed to the left sections of the screw shafts are respectively received in the left recess and the right recess of one of the masses and the nuts screwed to the right sections of the screw shafts are respectively received in the left recess and the right recess of the other mass, thereby the masses can move synchronously with the nuts.

9. The flywheel-based energy supply and storage system of claim 7, wherein the spring member comprises a pair of spring elements wherein the central portion of each mass is provided with a left groove and a right groove, one end of each spring element is fixed in the left groove of one mass by a first pin, while the other end is fixed in the left groove of the other mass by a second pin.

10. The flywheel-based energy supply and storage system of claim 7, wherein the spring member comprises four spring elements, each comprising a first spring and a second spring, the second spring housed within the first spring wherein one end of each spring element abuts against the mass, while the other end rests against the annular wall such that each spring element is disposed between the mass and the annular wall.

11. The flywheel-based energy supply and storage system of claim 7, wherein the spring member comprises four sets of disc spring member, each comprises a support post and a plurality of disc spring plates fitted onto the spring post, forming a stacked elastic cushioning structure, one end of the spring post is fixed to the annular wall, while the other end is positioned within a positioning groove of the mass.
